(19) United States
(12) Patent Application Publication
(10) Pub. No.: US 2025/0368896 A1
(43) Pub. Date: Dec. 4, 2025

(54) LIQUID CRYSTAL PANEL

(71) Applicant: Sharp Display Technology Corporation, Kameyama City (JP)

(72) Inventor: Hiroaki ASAGI, Kameyama City (JP)

(21) Appl. No.: 19/208,906

(22) Filed: May 15, 2025

(30) Foreign Application Priority Data
May 30, 2024 (JP) 2024-088046

(51) Int. Cl. C09K 19/12; C09K 19/04; C09K 19/18; C09K 19/20; C09K 19/30; C09K 19/32; G02F 1/1337; G02F 1/137

(52) U.S. Cl. CPC C09K 19/12; C09K 19/18; C09K 19/2007; C09K 19/3003; C09K 19/322; G02F 1/133711; G02F 1/13706; C09K 2019/0466; C09K 2019/122; C09K 2019/123; C09K 2019/183; C09K 2019/2042; C09K 2019/2078; C09K 2019/3004; C09K 2019/3016

(57) ABSTRACT

Provided is a liquid crystal panel in which the liquid crystal has excellent horizontal alignment properties and excellent high-speed response. The liquid crystal panel includes a pair of substrates and a liquid crystal layer between the pair of substrates. At least one of the pair of substrates includes an alignment film on a surface facing the liquid crystal layer. The alignment film contains a polymer having at least one of a group represented by the following formula (1) or a group represented by the following formula (2). The liquid crystal layer contains a liquid crystal material that contains a first compound represented by the following formula (3) and a second compound having a structure in which at least one polar group selected from the group consisting of F, CN, SCN, and OCₙH₂ₙ₊₁ is bonded to a phenylene ring.

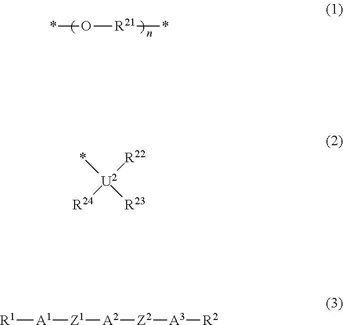

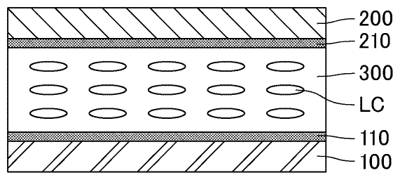

### CROSS-REFERENCE TO RELATED APPLICATIONS

The present application claims priority under 35 U.S.C. § 119 to Japanese Patent Application No. 2024-088046 filed on May 30, 2024, the contents of which are incorporated herein by reference in their entirety.

### BACKGROUND OF THE INVENTION

### Field of the Invention

The disclosure relates to liquid crystal panels.

### Description of Related Art

In recent years, liquid crystal panels have been proposed that utilize weak anchoring alignment films, which have a weaker anchoring strength than conventional alignment films (see, for example, JP 2018-141870 A and JP 2010-527382 T). Use of weak anchoring alignment films is expected to provide liquid crystal panels with lower power consumption and faster response time than conventional liquid crystal panels.

### BRIEF SUMMARY OF THE INVENTION

In liquid crystal panels including weak anchoring alignment films, alignment control is difficult due to the weak anchoring. In particular, in the FFS mode with horizontal alignment and weak anchoring, when high Δn liquid crystal is used and a narrow cell gap is applied to achieve high-speed response, a large pre-tilt occurs. This causes the display to have a whitened appearance when viewed from an oblique angle. Furthermore, since horizontal alignment is lost, the panel can no longer function in the FFS mode or the IPS mode.

In particular, when a photoalignment film for horizontal alignment is placed on one side of the liquid crystal layer instead of a rubbing alignment film, or when a weak anchoring alignment film is placed on each side of the liquid crystal layer, the pre-tilt direction (the direction in which liquid crystal molecules rise) does not fix, leading to alignment defects due to reverse tilt.

To achieve high-speed response in liquid crystal panels, high Δn liquid crystal and low-viscosity (low γ1) liquid crystal are commonly used. To increase the Δn, liquid crystal molecules with a biphenyl skeleton or a terphenyl skeleton or liquid crystal molecules having a naphthalene structure, which is a fused ring, in the molecular structure are used. To reduce the viscosity, molecules such as bicyclohexane molecules are used. According to the investigations by the present inventors, these liquid crystal molecules interact with a weak anchoring alignment film at the interface, and thus, the molecules have a pre-tilt, and in significant cases, they align vertically.

In response to the above issues, an object of the present invention is to provide a liquid crystal panel in which the liquid crystal has excellent horizontal alignment properties and excellent high-speed response.

(1) One embodiment of the present invention is directed to a liquid crystal panel including a pair of substrates and a liquid crystal layer between the pair of substrates, at least one of the pair of substrates including an alignment film on a surface facing the liquid crystal layer, the alignment film containing a polymer having at least one of a group represented by the following formula (1) or a group represented by the following formula (2), the liquid crystal layer containing a liquid crystal material that contains a first compound represented by the following formula (3) and a second compound having a structure in which at least one polar group selected from the group consisting of F, CN, SCN, and OCₙH₂ₙ₊₁ is bonded to a phenylene ring, the formulas (1) and (2) being as follows:

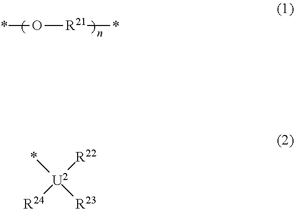

wherein, in the formula (1), * represents a binding site; R²¹ represents a C2-C4 hydrocarbon group; and n represents an integer of 1 or more, and in the formula (2), * represents a binding site; U² represents a carbon atom or a silicon atom; and R²², R²³, and R²⁴ each independently represent a hydrogen atom or a hydrocarbon group, where at least one of R²², R²³, or R²⁴ is a hydrocarbon group having four or more carbon atoms, the formula (3) being as follows:

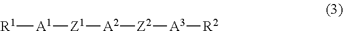

wherein R¹ and R² each independently represent CₙH₂ₙ₊₁, OCₙH₂ₙ₊₁, CN, SCN, F, or C≡C, where CₙH₂ₙ₊₁ is optionally partially substituted with an alkenyl; A¹, A², and A³ each independently represent a phenylene ring or a cyclohexylene ring; Z¹ and Z² each independently represent a single bond, CH═N, CF₂O, COO, or C≡C; and at least one of A² or A³ has a polar group selected from the group consisting of F, CN, Cl, and Br bonded thereto, where the number of polar groups bonded to A² and A³ is 2 or more.

(2) In an embodiment of the present invention, the liquid crystal panel includes the structure (1), and the liquid crystal material further contains at least one of a compound represented by the following formula (5), a compound represented by the following formula (6), or a compound represented by the following formula (7):

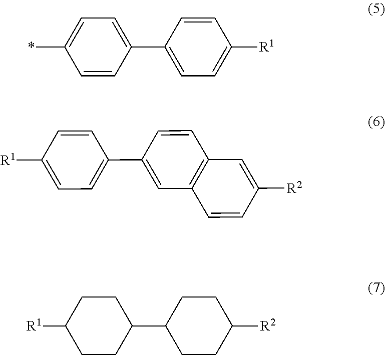

wherein, in the formula (5), * represents a binding site; and in the formulas (5), (6), and (7), R¹ and R² each independently represent a C1-C6 alkyl group or a C2-C6 alkenyl group.

(3) In an embodiment of the present invention, the liquid crystal panel includes the structure (1) or (2), and at least two of the polar groups bonded to A² and A³ in the formula (3) for the first compound are F.

(4) In an embodiment of the present invention, the liquid crystal panel includes the structure (1), (2), or (3), and at least one of Z¹ or Z² in the formula (3) for the first compound is COO.

(5) In an embodiment of the present invention, the liquid crystal panel includes the structure (1), (2), (3), or (4), and the liquid crystal material has a birefringence of 0.15 or higher.

(6) In an embodiment of the present invention, the liquid crystal panel includes the structure (1), (2), (3), (4), or (5), and the liquid crystal material has an absolute value of anisotropy of dielectric constant of 3 or less.

(7) In an embodiment of the present invention, the liquid crystal panel includes the structure (1), (2), (3), (4), (5), or (6), the liquid crystal material contains liquid crystal molecules, and 30% by weight or higher of the liquid crystal molecules have three or more ring structures selected from the group consisting of a phenylene ring and a cyclohexylene ring.

(8) In an embodiment of the present invention, the liquid crystal panel includes the structure (1), (2), (3), (4), (5), (6), or (7), and the liquid crystal material contains an alkenyl compound.

(9) In an embodiment of the present invention, the liquid crystal panel includes the structure (8), and a percentage of the alkenyl compound in the liquid crystal material is 70% by weight or lower.

(10) In an embodiment of the present invention, the liquid crystal panel includes the structure (1), (2), (3), (4), (5), (6), (7), (8), or (9), and the alignment film is a photoalignment film.

(11) In an embodiment of the present invention, the liquid crystal panel includes the structure (1), (2), (3), (4), (5), (6), (7), (8), (9), or (10), and the liquid crystal layer has a thickness of 2 μm or less.

The present invention can provide a liquid crystal panel in which the liquid crystal has excellent horizontal alignment properties and excellent high-speed response.

### BRIEF DESCRIPTION OF THE DRAWING

The attached FIGURE is a schematic cross-sectional view showing an example of the structure of a liquid crystal panel according to the present invention.

### DETAILED DESCRIPTION OF THE INVENTION

Hereinafter, embodiments of the present invention are described in detail with reference to the drawing.

### Embodiment 1

The liquid crystal panel according to the present invention may be a liquid crystal panel for use in liquid crystal display (LCD) devices or a liquid crystal panel for use in devices other than display devices. When used in liquid crystal display devices, the liquid crystal panel is preferably driven by a horizontal alignment mode (transverse electric field mode) such as the fringe field switching (FFS) mode or the in-plane switching (IPS) mode. Examples of the liquid crystal panel for use in devices other than display devices include liquid crystal lenses.

The attached FIGURE is a schematic cross-sectional view showing an example of the structure of the liquid crystal panel according to the present invention. The liquid crystal panel shown in the attached FIGURE includes: a pair of substrates consisting of a first substrate 100 and a second substrate 200; and a liquid crystal layer 300 containing liquid crystal molecules LC. The first substrate 100 includes a first alignment film 110 on its surface facing the liquid crystal layer 300, and the second substrate 200 includes a second alignment film 210 on its surface facing the liquid crystal layer 300. The first substrate 100 preferably includes conductive lines and electrodes for applying a voltage to the liquid crystal layer 300, and may be, for example, a TFT array substrate. The second substrate 200 may or may not include conductive lines and electrodes for applying a voltage to the liquid crystal layer 300.

The first alignment film and the second alignment film are preferably horizontal alignment films, specifically those capable of controlling the pre-tilt angle of the liquid crystal in contact with the corresponding alignment film to preferably 1 degree or less, particularly preferably 0 degrees. In the present disclosure, the “pre-tilt angle of the liquid crystal” refers to the angle of inclination of the major axes of the liquid crystal molecules with respect to the alignment film surface when no voltage is applied to the liquid crystal layer.

The first alignment film and the second alignment film may each be any type of alignment film such as a rubbed alignment film that has been subjected to a rubbing treatment as an alignment treatment or a photoalignment film that has photofunctional groups and has been subjected to a photoalignment treatment as an alignment treatment. Since a photoalignment treatment achieves high precision patterning of the in-plane alignment control force, the first alignment film and the second alignment film are preferably photoalignment films.

At least one of the first alignment film or the second alignment film contains a polymer having at least one of a group represented by the formula (1) below or a group represented by the formula (2) below. The alignment films containing a polymer having at least one of a group represented by the formula (1) below or a group represented by the formula (2) below have a hydrocarbon group R²¹ and/or hydrocarbon groups R²², R²³, and R²⁴ and have a structure that is highly compatible with liquid crystal. Thus, the alignment films have weak azimuthal anchoring (anchoring in the in-plane direction) and function as weak anchoring alignment films. In the polymer, preferably, the hydrocarbon groups are present in side chains. The “weak anchoring alignment film(s)” in the present disclosure refer to a film whose in-plane alignment control force on liquid crystal molecules is weaker than the intermolecular force between liquid crystal molecules, and which alone cannot uniaxially align the liquid crystal molecules in any direction. The weak anchoring alignment films may each be a “zero anchoring alignment film”, which has no in-plane alignment control force on liquid crystal molecules. Here, polar anchoring (anchoring in the thickness direction of the liquid crystal layer) is greatly influenced by the pre-tilt angle of the liquid crystal. In the case of a horizontal alignment film, an energy barrier prevents liquid crystal molecules from rising, so that even a weak anchoring alignment film has strong polar anchoring.

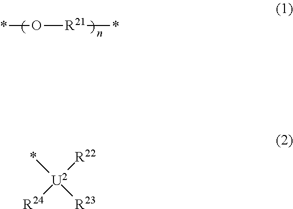

In the formula (1), * represents a binding site, R²¹ represents a C2-C4 hydrocarbon group, and n represents an integer of 1 or more. In the formula (2), * represents a binding site, U² represents a carbon atom or a silicon atom, and R²², R²³, and R²⁴ each independently represent a hydrogen atom or a hydrocarbon group, where at least one of R²², R²³, or R²⁴ is a hydrocarbon group having four or more carbon atoms. The hydrocarbon groups for R²¹, R²², R²³, and R²⁴ may contain a double bond, and are preferably alkyl groups.

Examples of the polymer having a group represented by the formula (1) include polymers having a group represented by the following formula (1-A).

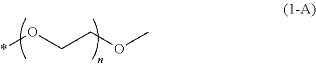

Examples of the polymer having a group represented by the formula (2) include polymers having a group represented by the following formula (2-A).

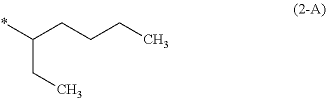 [SMILES: *C(CC)CCCC]

The polymer having at least one of a group represented by the formula (1) or a group represented by the formula (2) can be obtained, for example, by polymerizing 2-ethylhexyl acrylate described in JP H09-235555 A. Alternatively, the polymer may be obtained using a compound A-7 described in paragraph 0132 of WO 2022/260048.

In the present embodiment, both the first alignment film and the second alignment film may contain the polymer having at least one of a group represented by the formula (1) or a group represented by the formula (2), or only one of the first alignment film and the second alignment film may contain the polymer having at least one of a group represented by the formula (1) or a group represented by the formula (2).

The polymer may have both a group represented by the formula (1) and a group represented by the formula (2), may have only a group represented by the formula (1), or may have only a group represented by the formula (2).

The polymer may have any molecular skeleton such as polyimide, polyamic acid, polysiloxane, polyethylene glycol, polyacrylate (methacrylate), or polyamide.

From the viewpoint of improving electrical properties and coating properties, the first alignment film and the second alignment film may contain a polymer different from the polymer having at least one of a group represented by the formula (1) or a group represented by the formula (2). In other words, each of the first alignment film and the second alignment film may contain a polymer free of a group represented by the formula (1) or (2). Examples of the polymer include polyamic acids, polyimides, polysiloxanes, and (meth)acrylic polymers.

The liquid crystal layer includes a liquid crystal material that contains a first compound represented by the following formula (3):

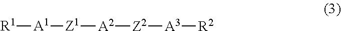

wherein R¹ and R² each independently represent CₙH₂ₙ₊₁ (alkyl), OCₙH₂ₙ₊₁ (alkoxy), CN, SCN, F, or C≡C, where CₙH₂ₙ₊₁ is optionally partially substituted with an alkenyl; A¹, A², and A³ each independently represent a phenylene ring or a cyclohexylene ring. A¹, A², and A³ are effective for increasing the birefringence Δn of the liquid crystal material. Z¹ and Z² each independently represent a single bond, CH═N, CF₂O, COO, or C≡C. These groups, excluding a single bond, for Z¹ and Z² each function as a spacer in the molecular skeleton (hereinafter also referred to as a “spacer group”). Preferred of these are COO and CF₂O. Particularly preferably, at least one of Z¹ or Z² is COO (an ester bond). At least one of A² or A³ has a polar group selected from the group consisting of F, CN, Cl, and Br bonded thereto. Preferably, groups bonded to A² and A³ (excluding Z¹, Z², and R²) are selected from H, F, CN, Cl, and Br. Preferably, all groups bonded to A² and A³ are located on one side of the molecular long axis. The number of polar groups bonded to A² and A³ is 2 or more. Preferably, the polar groups include F (a fluorine atom), and particularly preferably, at least two of all groups bonded to A² and A³ are F.

The liquid crystal material of the liquid crystal layer further contains a second compound having a structure in which at least one polar group selected from the group consisting of F, CN, SCN, and OCₙH₂ₙ₊₁ is bonded to a phenylene ring. The structure of the second compound is represented by the following formula (4):

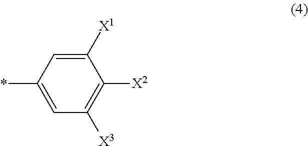

wherein * represents a binding site; and X¹, X², and X³ each independently represent H, F, CN, SCN, or OCₙH₂ₙ₊₁, where at least one of X¹, X², and X³ is F, CN, SCN, or OCₙH₂ₙ₊₁.

The first compound and the second compound are each preferably a liquid crystal molecule having a polar group(s) along its short axis direction (hereinafter, also referred to as “short-axis polar group liquid crystal”). The polar group(s) is preferably CN, SCN, F, CN, Cl, or Br, for example. Here, a compound represented by the formula (3) having only one polar group is considered to be neutral liquid crystal, which has no polarity, in the liquid crystal material industry, and does not fall under the category of short-axis polar group liquid crystal.

In the first compound and the second compound, a molecule having a polar group(s) along its long axis direction preferably has a CF₂O group as a spacer group, whereas a molecule having a polar group(s) along its short axis direction preferably has a COO group as a spacer group. Thereby, the polarity and response of the liquid crystal can be improved in a well-balanced manner.

In the liquid crystal panel of the present embodiment, use of the first compound represented by the formula (3) can increase the birefringence Δn of the liquid crystal material without increasing the proportion of molecules with a biphenyl or terphenyl skeleton. As a result, while a liquid crystal material with a high Δn (for example, a liquid crystal material with a birefringence Δn of 0.2) is used, the generation of a pre-tilt can be suppressed and horizontal alignment can be achieved. In the first compound, the presence of a spacer group (any of the above-listed groups, excluding a single bond, for Z¹ and Z² in the formula (3)) between the benzene rings and the presence of polar groups along the short axis direction of the molecule (modification generally used for negative liquid crystal is performed) are also effective in preventing the generation of a pre-tilt. Use of a high Δn liquid crystal material can reduce the cell gap of the liquid crystal panel, and as a result, a high-speed response can be achieved.

Further, combination use of the first compound represented by the formula (3) and the second compound containing a group represented by the formula (4) can reduce the anisotropy of dielectric constant Δε of the liquid crystal material, thereby moderating the steepness of the change in voltage-transmittance (V-T) properties, which is specific to weak anchoring alignment films.

In view of these, the liquid crystal panel of the present embodiment can achieve excellent overall performance in terms of horizontal alignment (the generation of a pre-tilt is suppressed), response time, driving voltage, reliability, etc.

Specific examples of the first compound include compounds represented by the chemical formulas below. The symbols R in the chemical formulas below correspond to R¹ and/or R² in the formula (3), and are each independently CₙH₂ₙ₊₁ (alkyl), OCₙH₂ₙ₊₁ (alkoxy), CN, SCN, F, or C≡C, where CₙH₂ₙ₊₁ is optionally partially substituted with an alkenyl. The symbols (F) in the chemical formulas may be replaced by a fluorine atom or a hydrogen atom.

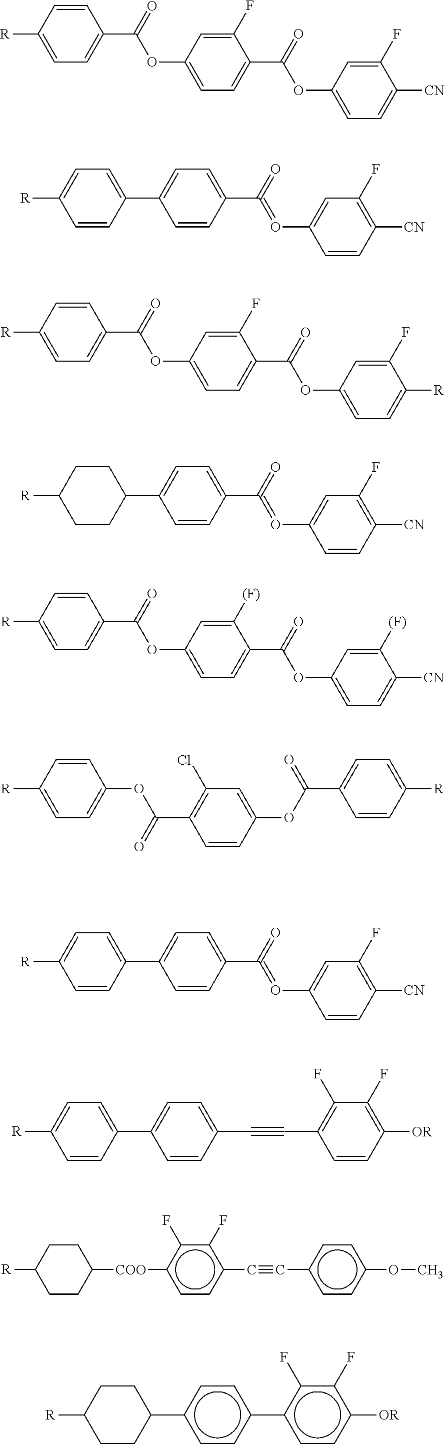

Specific examples of the second compound include compounds represented by the chemical formulas below. The symbols R in the chemical formulas below are each independently CnH₂ₙ₊₁ (alkyl), OCₙH₂ₙ₊₁ (alkoxy), CN, SCN, F, or C≡C, where CₙH₂ₙ₊₁ is optionally partially substituted with an alkenyl.

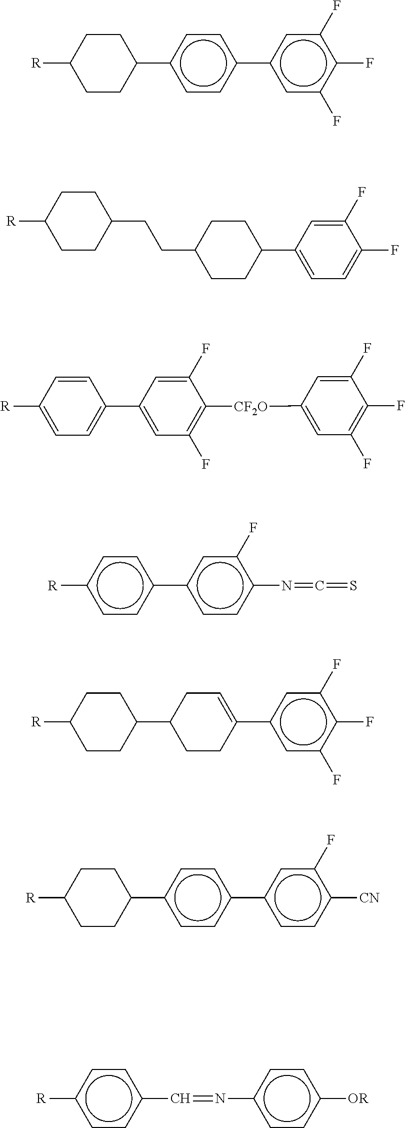

The first compound and the second compound are not limited to the above examples, and for example, may be any of the compounds described in paragraphs 0051 and 0052 of WO 2017/034023.

The liquid crystal material may be a liquid crystal material having a positive anisotropy of dielectric constant Δε (hereinafter also referred to as a “positive liquid crystal”), or a liquid crystal material having a negative anisotropy of dielectric constant Δε (hereinafter also referred to as a “negative liquid crystal”). The absolute value of anisotropy of dielectric constant |Δε| is preferably 3 or less, more preferably 2 or less. If the |Δε| is more than 3, the rate of change in transmittance with respect to the voltage applied to the liquid crystal layer (V-T curve) is steep, and control of the transmittance is thus difficult. For example, when the |Δε| is 4, the voltage at which the transmittance reaches a maximum is about 3.5 V, and the V-T curve is steeper than usual. When the |Δε| is 3 or less, the voltage at which the transmittance reaches a maximum exceeds 4 V, and the steepness reduces. The smaller the |Δε| is, the higher the reliability tends to be.

The liquid crystal material is preferably a positive liquid crystal, and specifically preferably has a positive anisotropy of dielectric constant As at a driving frequency of 1 kHz. In such a positive liquid crystal, preferably, a liquid crystal molecule has polar groups along its long axis direction. Use of a positive liquid crystal allows for well-balanced adjustment in terms of the degree of freedom in designing the liquid crystal material, decreasing viscosity, increasing the Δn, the anisotropy of dielectric constant Δε, high reliability, etc.

Here, since the driving frequency of a liquid crystal panel is usually 1 Hz to 360 Hz, the liquid crystal material preferably has a positive anisotropy of dielectric constant Δε at a frequency within the range of 1 Hz to 1 kHz.

The liquid crystal material is preferably a mixture of multiple liquid crystal molecules, and more preferably contains both a liquid crystal molecule having polar groups along its long axis direction and a liquid crystal molecule having polar groups along its short axis direction. The liquid crystal material may contain a molecule having both a polar group along its short axis direction and a polar group along its long axis direction. The molecule having both a polar group along its short axis direction and a polar group along its long axis direction preferably has polarity in the direction of the short axis as a dipole moment, in other words, functions as a negative liquid crystal when viewed as a whole molecule.

If a polar group is added to a positive liquid crystal along the short axis direction, the Δε of the positive liquid crystal becomes small. Thus, a polar group is not added to a positive liquid crystal along the short axis direction in conventional materials development. Even if a polar group is added to a positive liquid crystal along the short axis direction, the small Δε leads to a restriction (or disadvantage) of a higher driving voltage. On the other hand, in the case of the liquid crystal panel of the present disclosure including an alignment film containing a polymer having at least one of a group represented by the formula (1) or a group represented by the formula (2), a lower driving voltage is achieved owing to the weak anchoring of the alignment film. Thus, the anisotropy of dielectric constant Δε of the liquid crystal material may be so small that it is not considered in the prior art. In other words, the combination of an alignment film containing a polymer having at least one of a group represented by the formula (1) or a group represented by the formula (2) and a liquid crystal material containing the first compound represented by the formula (3) and the second compound containing a group represented by the formula (4) can be said to be a particularly good configuration. The anisotropy of dielectric constant Δε can also be reduced by increasing the proportion of the alkenyl compound, which is described below. However, since a too high proportion of the alkenyl compound can also cause a tilt (alignment instability), the anisotropy of dielectric constant Δε is preferably reduced by mixing positive liquid crystal molecules and negative liquid crystal molecules.

The liquid crystal material preferably has a birefringence Δn of 0.13 or higher. When the birefringence Δn of the liquid crystal material is high, the thickness of the liquid crystal layer can be reduced. The birefringence Δn of the liquid crystal material is more preferably 0.15 or higher, and the upper limit is, for example, 0.2 or lower, but not limited thereto. The thickness of the liquid crystal layer is preferably, but not limited to, 2 μm or less. This allows a liquid crystal panel to have a faster response time.

In the present disclosure, unless otherwise specified, optical properties such as a birefringence Δn are indicated by a value measured using visible light with a wavelength of 550 nm.

Preferably, in the liquid crystal material, 30% or higher of the liquid crystal molecules have three or more ring structures selected from the group consisting of a phenylene ring and a cyclohexylene ring. This can increase the birefringence Δn of the liquid crystal material. These liquid crystal molecules may have three or more phenylene rings or three or more cyclohexylene rings. The liquid crystal molecules may have both a phenylene ring and a cyclohexylene ring, and the sum of the number of phenylene rings and the number of cyclohexylene rings may be 3 or more. For example, the number of phenylene rings may be 2 and the number of cyclohexylene rings may be 1. The weight percentage of the liquid crystal molecules having three or more ring structures selected from the group consisting of a phenylene ring and a cyclohexylene ring is more preferably 5% or higher. The upper limit thereof is, for example, 10% or lower, but is not limited thereto.

The liquid crystal layer preferably has a retardation of 200 to 280 nm. The retardation is determined by the product of the birefringence Δn and the thickness d of the liquid crystal layer (Δn×d). The value of retardation in the above-described range is very small compared to the value set in the normal FFS mode. When the weak anchoring alignment film as disclosed herein is used, the liquid crystal molecules move efficiently when a voltage is applied, so that the phase difference can be reduced. Therefore, the thickness of the liquid crystal layer can be reduced, and a faster response time can be achieved.

The liquid crystal material preferably contains an alkenyl compound (a molecule having an alkenyl group). This can reduce the viscosity of the liquid crystal material and achieve a faster response time. An example of the alkenyl compound is trans-4-propyl-4′-vinyl-1,1′-bicyclohexane. The first compound represented by the formula (3) and/or the second compound containing a group represented by the formula (4) may have an alkenyl group. To stabilize the alignment, the percentage of the alkenyl compound in the liquid crystal material is preferably 80% by weight or lower, more preferably 70% by weight or lower. The percentage of the alkenyl compound in the liquid crystal material is preferably 30% by weight or higher.

The liquid crystal material preferably contains at least one of a compound represented by the formula (5) below, a compound represented by the formula (6) below, or a compound represented by the formula (7) below. The presence of a compound having a biphenyl skeleton as represented by the formula (5) below or a compound having a naphthalene structure, which is a fused ring, in its molecular structure as represented by the formula (6) below allows the liquid crystal material to have a higher birefringence Δn. The presence of a bicyclohexane compound as represented by the following formula (7) allows the liquid crystal material to have lower viscosity.

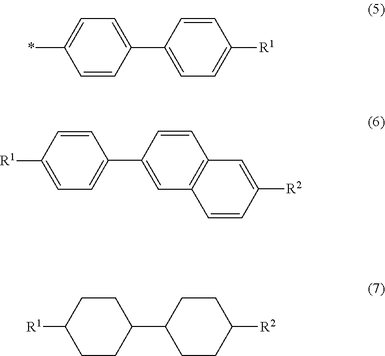

In the formula (5), * represents a binding site. In the formulas (5), (6), and (7), R¹ and R² each independently represent a C1-C6 alkyl group or a C2-C6 alkenyl group.

The liquid crystal material may contain a compound represented by the formula (8) below or a compound represented by the formula (9) below. The presence of a compound having a biphenyl skeleton as represented by the formula (8) below or a compound having a terphenyl skeleton as represented by the formula (9) below allows the liquid crystal material to have a higher birefringence Δn.

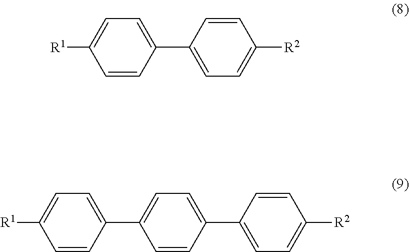

In the formulas (8) and (9), R¹ and R² each independently represent a C1-C6 alkyl group or a C2-C6 alkenyl group.

The compounds represented by the formulas (5) to (9) interact with the weak anchoring alignment film at the interface and easily align vertically. Thus, the compounds are preferably used in smaller amounts than the first compound represented by the formula (3) and the second compound containing a group represented by the formula (4).

### EXAMPLES AND COMPARATIVE EXAMPLES

Hereinafter, the effects of the present invention are described based on examples and comparative examples. The examples, however, are not intended to limit the scope of the present invention.

### Example 1

A first substrate (TFT substrate) including electrodes and thin film transistors for the FFS mode and a second substrate (CF substrate) including spacers (photospacers) formed of a photosensitive resin and color filters were prepared. A photodecomposition alignment film was formed on the TFT substrate, and a weak anchoring alignment film was formed on the CF substrate. The photodecomposition alignment film subjected to photoalignment treatment exhibits an alignment control force and is not a weak anchoring alignment film. Next, a sealant was applied to the second substrate, and the first substrate and the second substrate were bonded together with a liquid crystal material in between to prepare a liquid crystal panel.

The weak anchoring alignment film was made of a polymer having a group represented by the following formula (2-A).

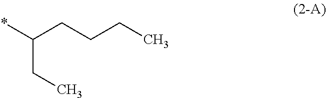 [SMILES: *C(CC)CCCC]

The liquid crystal material contained a compound represented by the chemical formula (A) below (compound A), a compound represented by the chemical formula (B) below (compound B), a compound represented by the chemical formula (C) below (compound C), and a compound represented by the chemical formula (D) below (compound D). The weight ratio of the compound A to the compound B was set to 1:1. The amount of the compound C was 35% by weight in the total composition. The amount of the compound D was 6% by weight in the total composition. The liquid crystal material had a birefringence Δn of 0.15 and an anisotropy of dielectric constant Δε of 1.3.

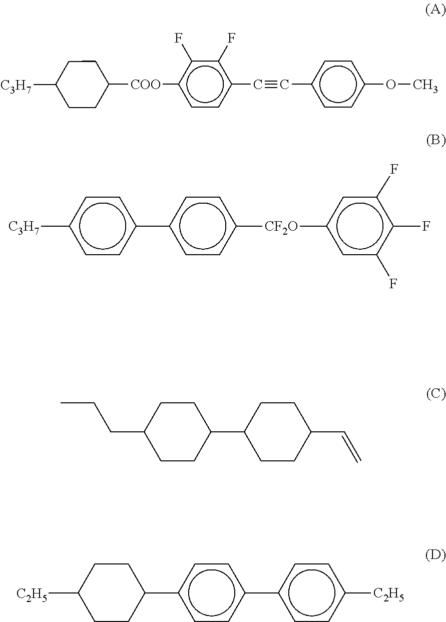

The compound A is a liquid crystal compound having polar groups along the short axis direction, which contributes to increasing the Δn and decreasing the |Δε| and can achieve an excellent response time and driving voltage. The compound B is a liquid crystal compound having polar groups along the long axis direction, which contributes to the adjustment of the Δε, and can adjust the driving voltage. The compound C is a low viscous liquid crystal compound, and can achieve an excellent response time. The compound D contributes to increasing the Δn and can achieve an excellent response time. Use of the compounds A to D prevents generation of a pre-tilt and can achieve stable horizontal alignment.

Crossed-Nicols polarizers were attached to the finished liquid crystal panel, and the alignment state of the liquid crystal layer in the absence of applied voltage was observed visually. This confirmed that good black display was achieved when viewed from both the front and an oblique angle. Furthermore, the liquid crystal panel was able to switch from black display to white display when 4 V was applied at a driving frequency in the range of 1 Hz to 360 Hz. Moreover, the liquid crystal panel switched from white to black when a black voltage of 200 mV was applied. The response time consisted of a rise time of 18 msec and a fall time of 22 msec. The liquid crystal panel thus obtained was able to be driven with low power consumption over a wide temperature range without depending on temperature like dual-frequency driving and had excellent high-speed response.

The voltage holding ratio of the liquid crystal panel was measured using a holding ratio measuring system Model 6254 available from Toyo Corporation. An aging test was carried out by leaving the panel on a backlight at 70° C. for 1000 hours, and the voltage holding ratio after the test was also measured in the same manner. The voltage holding ratio before the aging test was 99%, and the voltage holding ratio after the aging test was 95%.

### Example 2

A liquid crystal panel of Example 2 was produced as in Example 1, except that the material of the alignment film on the CF substrate and the liquid crystal material were changed.

The alignment film on the CF substrate was a weak anchoring alignment film, and contained a polymer having a group represented by the following formula (1-A).

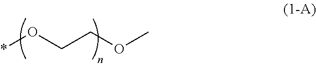

The liquid crystal material contained a compound represented by the chemical formula (E) below (compound E) and a compound represented by the chemical formula (F) below (compound F). The amount of the compound E was 12% by weight in the total composition. The amount of the compound F was 9% by weight in the total composition. The liquid crystal material had a birefringence Δn of 0.15 and an anisotropy of dielectric constant Δε of 1.3.

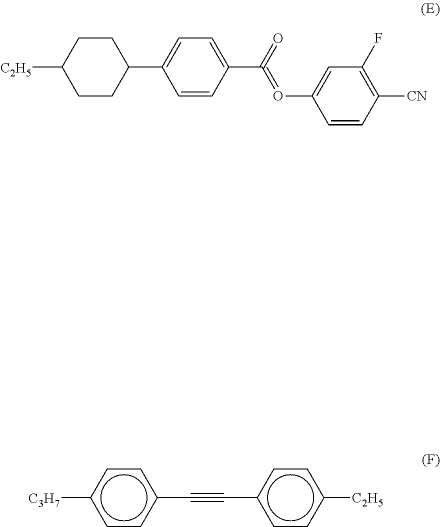

The compound E is a liquid crystal compound having polar groups along the long axis direction, which contributes to the adjustment of the Δε and can achieve the driving voltage. Also, the compound F is a liquid crystal compound having polar groups along the long axis direction, which contributes to increasing the Δn and can achieve an excellent response time. Use of the compounds E and F prevents generation of a pre-tilt and can achieve stable horizontal alignment.

As in Example 1, the alignment state of the liquid crystal layer in the absence of applied voltage was observed visually. This confirmed that good black display was achieved when viewed from both the front and an oblique angle. Furthermore, the liquid crystal panel was able to switch from white display to black display without high-frequency driving, and as for the response time, a fall time was 27 msec. The liquid crystal panel thus obtained was able to be driven with low power consumption over a wide temperature range and had excellent high-speed response.

### Comparative Example 1

A liquid crystal panel of Comparative Example 1 was produced as in Example 1, except that the liquid crystal material was changed. The liquid crystal material in Comparative Example 1 contained the compounds B, C, and D, but did not contain the compound A. The liquid crystal material had a birefringence Δn of 0.14 and an anisotropy of dielectric constant Δε of 4.8.

As in Example 1, the alignment state of the liquid crystal layer in the absence of applied voltage was observed visually. This confirmed that good black display was not achieved. In particular, when the panel was observed from an oblique angle, the black display appeared whitish, indicating the generation of a pre-tilt.

It is believed that if the amount of molecules with a biphenyl or terphenyl skeleton is increased too much in order to increase the Δn, or if the amount of molecules with a bicyclohexane skeleton or an alkyl/alkenyl structure is increased too much in order to reduce viscosity (low γ1), these molecules interact with the weak anchoring alignment film, so that the liquid crystal molecules easily align vertically.

### Comparative Example 2

A liquid crystal panel of Comparative Example 2 was produced as in Example 1, except that the liquid crystal material was changed. The liquid crystal material in Comparative Example 2 was a dual-frequency liquid crystal containing, as a main component, a compound represented by the chemical formula (G) below. The liquid crystal material did not contain the compounds A to D. The anisotropy of dielectric constant Δε of the liquid crystal material was 2.5.

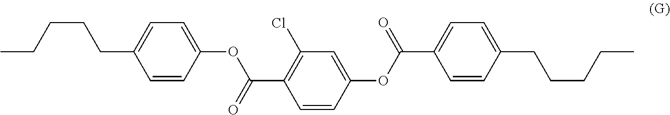 [SMILES: CCCCCc1ccc(OC(=O)c2ccc(OC(=O)c3ccc(CCCCC)cc3)cc2Cl)cc1]

As in Example 1, the alignment state of the liquid crystal layer in the absence of applied voltage was observed visually. This confirmed that good black display was achieved when viewed from both the front and an oblique angle. However, in this comparative example, the panel required high-frequency driving at 100 kHz or higher to switch from white display to black display, and the low power consumption characteristics of the panel were greatly impaired compared to the panel in Example 1.

### Example 3

A liquid crystal panel of Example 3 was produced as in Example 1, except that a color filter layer was provided on the first substrate instead of the second substrate. The first substrate used in Example 3 had a color filter on array (COA) structure. Liquid crystal molecules that form a conjugated system tend to have low reliability (light resistance); however, with a COA structure, the amount of light entering the liquid crystal layer from the backlight can be reduced by the color filter layer, resulting in a highly reliable liquid crystal panel.

As in Example 1, the alignment state of the liquid crystal layer in the absence of applied voltage was observed visually. This confirmed that good black display was achieved when viewed from both the front and an oblique angle.

In addition, as in Example 1, the voltage holding ratio was measured before and after the aging test. The voltage holding ratio before the aging test was 99%, and the voltage holding ratio after the aging test was 98%. This demonstrates that the decrease in the voltage holding ratio is smaller and the reliability is better in Example 3 than in Example 1.

### Example 4

In Example 4, instead of a liquid crystal display panel used to display images, a phase modulator was produced as a liquid crystal panel. Specifically, a first substrate including electrodes and thin film transistors for the IPS mode and a second substrate including photospacers were prepared. Neither the first substrate nor the second substrate included a color filter. The same weak anchoring alignment film as in Example 1 was formed on each of the first substrate and the second substrate. The weak anchoring alignment film was subjected to rubbing treatment. The liquid crystal material used was the same as that used in Example 1.

As in Example 1, the alignment state of the liquid crystal layer in the absence of applied voltage was observed visually. This confirmed that good alignment state was achieved when viewed from both the front and an oblique angle.

Next, linearly polarized light was incident on the liquid crystal panel of Example 4 to evaluate whether the panel functioned as a phase modulator. In the voltage-on state where a voltage was applied to the liquid crystal layer, the linearly polarized light was modulated to right-handed circularly polarized light, and in the voltage-off state, the linearly polarized light was modulated to left-handed circularly polarized light. This confirmed that a phase modulator was successfully obtained. Even when a voltage with a high frequency of 100 kHz or higher was applied instead of applying no voltage, the same effect was obtained as in the case of applying no voltage.

Example 4 demonstrates that the present invention is also applicable to liquid crystal panels other than the liquid crystal display panel of the present invention. A weak anchoring alignment film may be formed on only one substrate, as in Example 1, but Example 4 demonstrates that a weak anchoring alignment film may be formed on both substrates.

When the phase modulator of Example 4 is produced, a chiral agent may be added to the liquid crystal material.

What is claimed is:

1. A liquid crystal panel comprising:
a pair of substrates; and
a liquid crystal layer between the pair of substrates,
at least one of the pair of substrates including an alignment film on a surface facing the liquid crystal layer,
the alignment film containing a polymer having at least one of a group represented by the following formula (1) or a group represented by the following formula (2),
the liquid crystal layer comprising a liquid crystal material that comprises a first compound represented by the following formula (3) and a second compound having a structure in which at least one polar group selected from the group consisting of F, CN, SCN, and OCₙH₂ₙ₊₁ is bonded to a phenylene ring, the formulas (1) and (2) being as follows: 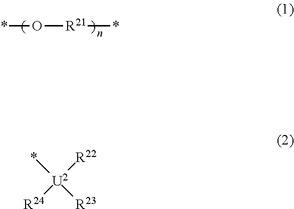
wherein, in the formula (1), * represents a binding site; R²¹ represents a C2-C4 hydrocarbon group; and n represents an integer of 1 or more, and in the formula (2), * represents a binding site; U² represents a carbon atom or a silicon atom; and R²², R²³, and R²⁴ each independently represent a hydrogen atom or a hydrocarbon group, where at least one of R²², R²³, or R²⁴ is a hydrocarbon group having four or more carbon atoms, the formula (3) being as follows: 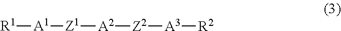
wherein R¹ and R² each independently represent CₙH₂ₙ₊₁, OCₙH₂ₙ₊₁, CN, SCN, F, or C≡C, where CₙH₂ₙ₊₁ is optionally partially substituted with an alkenyl; A¹, A², and A³ each independently represent a phenylene ring or a cyclohexylene ring; Z¹ and Z² each independently represent a single bond, CH═N, CF₂O, COO, or C≡C; and at least one of A² or A³ has a polar group selected from the group consisting of F, CN, Cl, and Br bonded thereto, where the number of polar groups bonded to A² and A³ is 2 or more.

2. The liquid crystal panel according to claim 1,
wherein the liquid crystal material further comprises at least one of a compound represented by the following formula (5), a compound represented by the following formula (6), or a compound represented by the following formula (7): 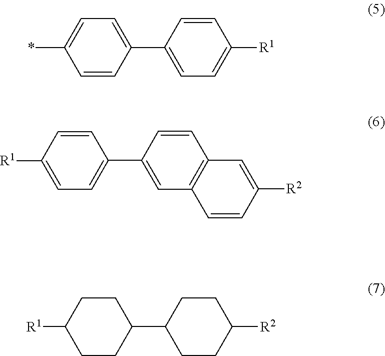
wherein, in the formula (5), * represents a binding site; and in the formulas (5), (6), and (7), R¹ and R² each independently represent a C1-C6 alkyl group or a C2-C6 alkenyl group.

3. The liquid crystal panel according to claim 1,
wherein at least two of the polar groups bonded to A² and A³ in the formula (3) for the first compound are F.

4. The liquid crystal panel according to claim 1,
wherein at least one of Z¹ or Z² in the formula (3) for the first compound is COO.

5. The liquid crystal panel according to claim 1,
wherein the liquid crystal material has a birefringence of 0.15 or higher.

6. The liquid crystal panel according to claim 1,
wherein the liquid crystal material has an absolute value of anisotropy of dielectric constant of 3 or less.

7. The liquid crystal panel according to claim 1,
wherein the liquid crystal material comprises liquid crystal molecules, and 30% by weight or higher of the liquid crystal molecules have three or more ring structures selected from the group consisting of a phenylene ring and a cyclohexylene ring.

8. The liquid crystal panel according to claim 1,
wherein the liquid crystal material comprises an alkenyl compound.

9. The liquid crystal panel according to claim 8,
wherein a percentage of the alkenyl compound in the liquid crystal material is 70% by weight or lower.

10. The liquid crystal panel according to claim 1,
wherein the alignment film is a photoalignment film.

11. The liquid crystal panel according to claim 1,
wherein the liquid crystal layer has a thickness of 2 μm or less.
